(19) United States
(12) Patent Application Publication
(10) Pub. No.: US 2007/0109685 A1
(43) Pub. Date: May 17, 2007

(54) Recording disk cartridge

(75) Inventor: Kengo Oishi, Odawara (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/599,405

(22) Filed: Nov. 15, 2006

(30) Foreign Application Priority Data
Nov. 16, 2005 (JP) 2005-331723

(51) Int. Cl. G11B 23/03

(52) U.S. Cl. 360/133

(57) ABSTRACT

A recording disk cartridge is provided including a recording disk medium, a cartridge case which contains the recording disk medium and has a case opening to cause the recording disk medium exposed outside, and a rotary shutter to open and close the case opening, in which in the cartridge case, a hub hole is formed to cause a hub supporting the recording disk medium to be exposed outside, in which a hub hole shutter including a shutter in which one edge is pivoted on an inner surface of the cartridge case and a fitting portion which fits with the hub is formed on the other edge, and in which the shutter of the hub hole shutter engages with the rotary shutter and turns in synchronization with turning of the rotary shutter to open and close a space between the hub hole and the hub.

### CROSS REFERENCE TO RELATED APPLICATIONS

This application claims the foreign priority benefit under Title 35, United States Code, §119(a)-(d) of Japanese Patent Application No. 2005-331723, filed on Nov. 16, 2005 in the Japan Patent Office, the disclosure of which is herein incorporated by reference in its entirety.

### BACKGROUND OF THE INVENTION

1. Field of the Invention

The invention relates to a recording disk cartridge, and more specifically, to a recording disk cartridge including a recording disk medium and a cartridge case which contains the recording disk medium.

2. Description of the Related Art

Conventionally, a recording disk cartridge is well-known which contains a recording disk medium such as a flexible magnetic disk medium with magnetic layers on both surfaces of a discoid support medium made of a polyester sheet or the like, an optical recording disk medium, a phase change disk medium, and so on in a cartridge case.

For instance, a conventional recording disk cartridge described in U.S. Pat. No. 6,256,168 is well known.

As shown in FIGS. 10A and 10B, the recording disk cartridge 800 described in U.S. Pat. No. 6,256,168 mainly includes a cartridge case 810, a rotary shutter 820 turnably provided inside the cartridge case 810, and a recording disk medium 830 rotatably provided inside the rotary shutter 820. The recording disk medium 830 includes a discoid flexible disk 831 and a hub 832 which supports the flexible disk 831. The recording disk cartridge 800 is mounted in a dedicated drive unit (not shown) before use.

The cartridge case 810 includes an upper shell 811 and a lower shell 812. An opening for access 813, which is wedge-shaped in a plane view, is formed so that a head of the drive unit can access the recording disk medium 830 when the recording disk cartridge 800 is mounted in the drive unit.

Moreover, a hub hole 815 is formed in the lower shell 812 so that a spindle of the drive unit can chuck the hub 832 when the recording disk cartridge 800 is mounted in the drive unit.

The rotary shutter 820 includes an upper shutter 823 and a lower shutter 824 which are discoid in shape. In each of the upper shutter 823 and the lower shutter 824, a notch 821 is formed so as to cause the recording disk medium 830 to be exposed outside through an opening for access 813.

Moreover, the rotary shutter 820 is turnably attached to the upper shell 811 of the cartridge case 810 so as to turn between a close position and an open position. When the rotary shutter 820 is located in the close position, the opening for access 813 of the cartridge case 810 is covered by a portion of the rotary shutter 820 except the notch 821. Therefore, the recording disk medium 830 is not exposed outside. When the rotary shutter 820 is located in the open position, the notch 821 of the rotary shutter 820 matches and aligns with the opening for access 813 of the cartridge case 810. Therefore, the recording disk medium 830 is exposed outside through both of the opening for access 813 and the notch 821. The rotary shutter 820 is pushed by a spring, which is not shown, to be located in the close position when the recording disk cartridge 1 is not mounted in the drive unit and in the open position when the recording disk cartridge 1 is mounted in the drive unit.

In addition, the rotary shutter 820 has a shutter hub hole 822 to cause the hub 832 to be exposed outside thorough the hub hole 815 of the cartridge case 810. The shutter hub hole 822 of the rotary shutter 820 matches and aligns with the hub hole 815 of the cartridge case 810. Therefore, a lower surface of the hub 832 is exposed outside through the shutter hub hole 822 and the hub hole 815.

### SUMMARY OF THE INVENTION

In the above-mentioned recording disk medium 830, as recording density increases year by year, a recording track width is getting narrower while a recording length is getting shorter. Therefore, in the magnetic disk cartridge, a read error easily occurs due to a very little dust between the magnetic disk medium and the magnetic head.

In view of the above, in the conventional recording disk cartridge 800, the opening for access 813 of the cartridge case 810 is covered by the rotary shutter 820 so that dust is prevented from entering the cartridge case 810 through the opening for access 813 when the recording disk cartridge 800 is not mounted in the drive unit.

The hub hole 815 of the cartridge case 810 is formed larger than the hub 832 of the recording disk medium 830 so that the hub 832 can move inside the hole 815. Accordingly, position of the hub 832 can be easily adjusted corresponding to position of the spindle of the drive unit when the spindle chucks the hub 832.

Thus, in the conventional recording disk cartridge 800, there is a space S between the hub hole 815 and the hub 832 since the hub hole 815 is larger than the hub 832. As a result, there is a problem that dust enters the cartridge case 810 through the space S.

In view of the above, it is an object of the present invention to provide a recording disk cartridge which minimizes dust entering a cartridge case.

To solve the problem, in one aspect of the present invention, there is provided a recording disk cartridge including a recording disk medium, a cartridge case which contains the recording disk medium and has a case opening to cause the recording disk medium to be exposed outside, and a rotary shutter which turns between the recording disk medium and the cartridge case in order to open and close the case opening. In the cartridge case, a hub hole is formed so as to cause a hub which supports the recording disk medium to be exposed outside. Moreover, a hub hole shutter includes a shutter in which one edge is pivoted on an inner surface of the cartridge case and a fitting portion is formed on another edge to fit with the hub. The shutter of the hub hole shutter engages with the rotary shutter and turns in synchronization with turning of the rotary shutter so as to open and close a space between the hub hole and the hub.

As described above, the recording disk cartridge includes the hub hole shutter having a shutter which turns in synchronization with turning of the rotary shutter to open and close the space between the hub hole of the cartridge case and the hub of the recording disk medium. The shutter closes the space between the hub hole and the hub when the rotary shutter closes the case opening. On the other hand, the shutter opens the space when the rotary shutter opens the case opening. As a result, when the recording disk cartridge is not mounted in the drive unit, the space between the hub hole and the hub can be covered by the hub hole shutter. Therefore, it is possible to prevent dust from entering the cartridge case through the space.

In the recording disk cartridge, the hub hole shutter may include a plurality of shutters. The one edge of each of the shutters is respectively pivoted on the cartridge case. In addition, the other edges of the shutters together surround the hub so as to close the space between the hub hole and the hub.

Thus, the plurality of shutters can together surround the hub so as to exactly close the space between the hub hole and the hub. In addition, each of the shutters is individually pivoted on the cartridge case. Therefore, shutters can be supported without overlap to open and close the space between the hub hole and the hub. As a result, the hub hole shutter can be thin so as to be employed for a thin recording disk cartridge.

In the recording disk cartridge, a slot in which a protrusion of the rotary shutter is inserted and engaged is formed in the shutter of the hub hole shutter.

Thus, the protrusion on the rotary shutter is inserted and engaged in the slot formed in the shutter so that the shutter can easily and exactly engage with the rotary shutter and the shutter can turn exactly in synchronization with turning of the rotary shutter.

In the recording disk cartridge, in the shutter of the hub hole shutter, a side of the other edge may be inclined toward the rotary shutter.

Thus, the side of the other edge in the shutter is inclined toward the rotary shutter so as to cause the side of the other edge in the shutter to approach the rotary shutter. Accordingly, the protrusion of the rotary shutter is inserted deep in the slot in the side of the other edge. Therefore, it is possible to prevent the protrusion of the rotary shutter from being detached from the slot in the side of the other edge which is free and shaky. Accordingly, the shutter can exactly turn.

In the above-mentioned recording disk cartridge, in the shutter of the hub hole shutter, an axis hole is formed in the one edge. An axis is protruded from an inner surface of the cartridge case by means of a burring process and inserted into the axis hole. Then, an end of the axis is crimped.

Thus, the shutter is supported by the cartridge case. Therefore, it is not required to attach an axis as a separate part to support the shutter. As a result, the shutter can be easily attached.

In the recording disk cartridge, the hub hole shutter may include a first shutter and a second shutter. The slots of the first shutter and the second shutter may be shaped in an arc whose centers are displaced from the turn center of the rotary shutter. In the slot of the first shutter, a side of the other edge may curve in a direction from the turn center of the rotary shutter toward outside.

### BRIEF DESCRIPTION OF THE DRAWINGS

The above and other aspects, other advantages and further features of the present invention will become more apparent by describing in detail illustrative, non-limiting embodiments thereof with reference to the accompanying drawings, in which:

FIG. 1A is a perspective view from the upper front side showing a recording disk cartridge according to the present embodiment;

FIG. 1B is a perspective view from the lower rear side showing the recording disk cartridge according to the present embodiment;

FIG. 2 is an exploded perspective view of the recording disk cartridge according to the present embodiment;

FIG. 3A is a perspective view from the upper front side showing a rotary shutter according to the present embodiment;

FIG. 3B is a perspective view from the lower rear side showing the rotary shutter according to the present embodiment;

FIG. 4 is a plan view from the lower side showing the recording disk cartridge according to the present embodiment;

FIG. 5 is a perspective view showing the recording disk cartridge according to the present embodiment inserted in the drive unit;

FIG. 6A is a plan view from the lower side showing a closed hub hole shutter in the recording disk cartridge according to the present embodiment;

FIG. 6B is a plan view from the lower side showing an open hub hole shutter in the recording disk cartridge according to the present embodiment;

FIG. 7A is a side sectional view showing a hub hole shutter in the recording disk cartridge according to the present embodiment;

FIG. 7B is a side sectional view showing how the hub hole shutter is attached in the recording disk cartridge according to the present embodiment;

FIG. 8 is a plan view from the lower side showing how the hub hole shutter opens in the recording disk cartridge according to the present embodiment;

FIG. 9 is a side sectional view showing the hub hole shutter in the recording disk cartridge according to another embodiment;

FIG. 10A is a perspective view from the upper front side showing a conventional recording disk cartridge; and

FIG. 10B is a perspective view from the lower rear side showing a conventional recording disk cartridge.

### DESCRIPTION OF THE PREFERRED EMBODIMENTS

Here will be described embodiments of the present invention in detail, referring to the accompanying drawings as needed.

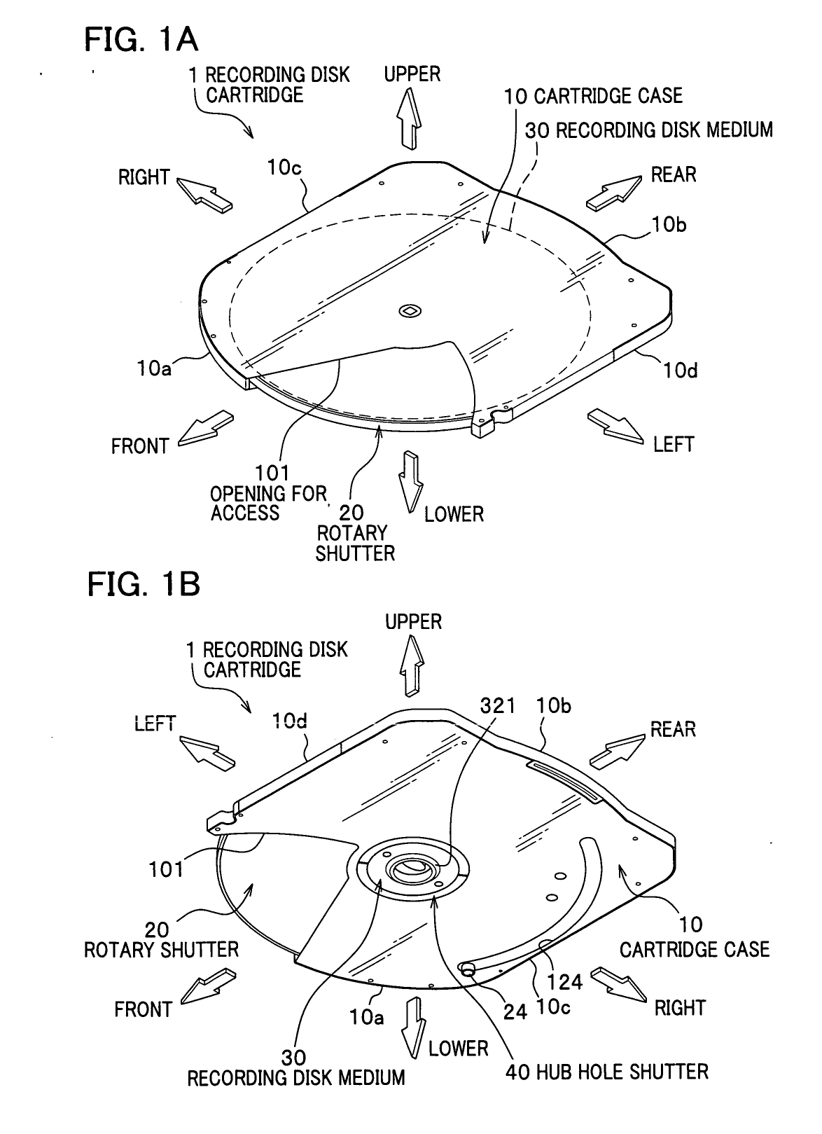

In the embodiment, directions will be described in accordance with front, rear, right, left, upper, and lower directions shown in FIGS. 1A and 1B.

<<Constitution of Recording Disk Cartridge 1>>

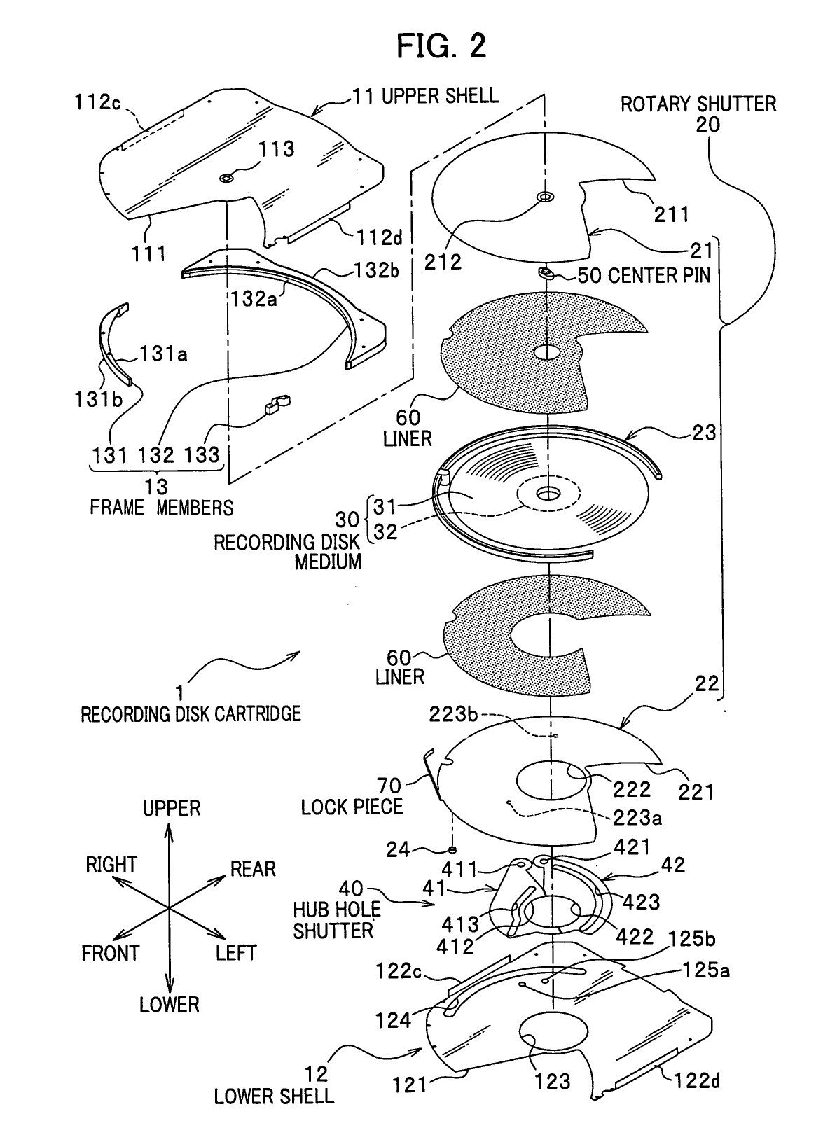

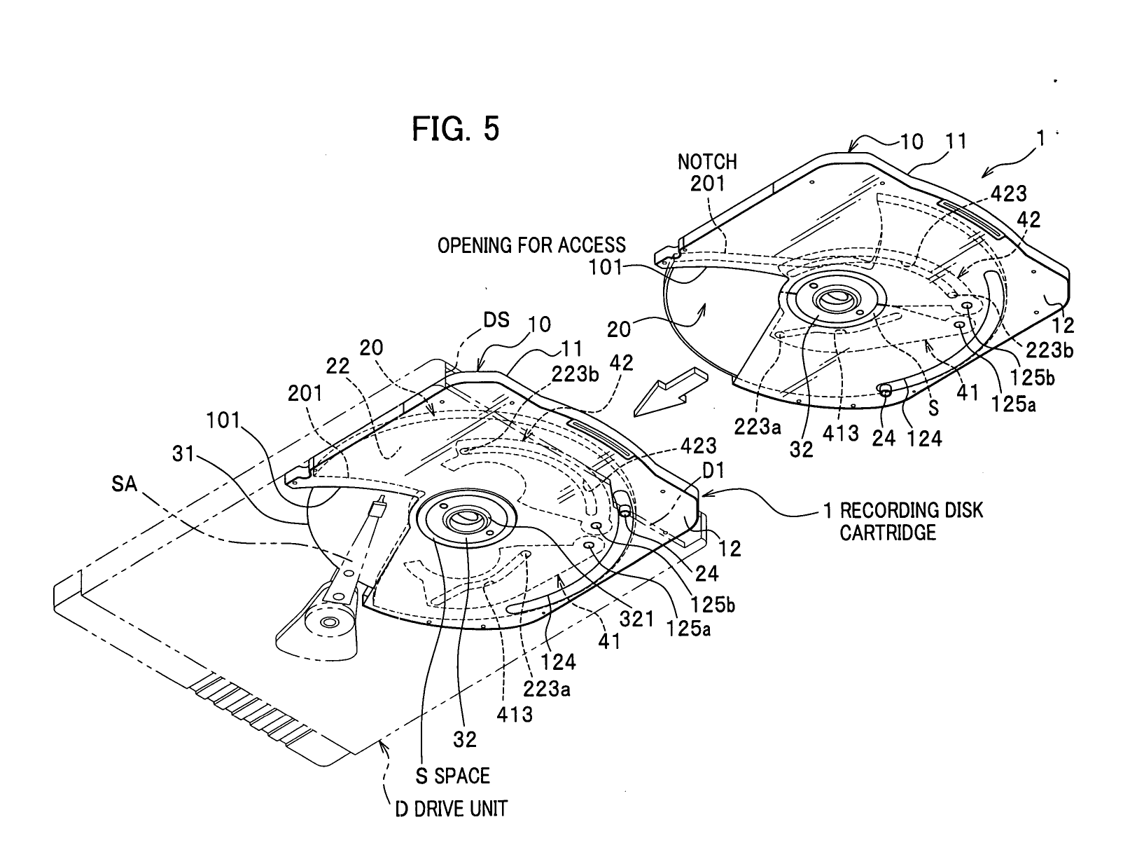

As shown in FIGS. 1A, 1B, and 2, a recording disk cartridge 1 according to the present embodiment mainly includes a cartridge case 10, a rotary shutter 20 provided turnably inside the cartridge case 10, a recording disk medium 30 provided rotatably inside the rotary shutter 20, a hub hole shutter 40 provided under the rotary shutter 20 inside the cartridge case 10. Thus, the recording disk cartridge 1 is inserted in a dedicated drive unit D (See FIG. 5) from the front side before use.

<Cartridge Case 10>

As shown in FIGS. 1A and 1B, a cartridge case 10 is a thin box case to contain the recording disk medium 30. In the cartridge case 10, a front edge 10a is formed in an arc (an arch) shape in a plane view while a rear edge 10b, a right edge 10c, and a left edge 10d are formed substantially linearly in a plane view. The center of the rear edge 10b bulges backward a little compared with the right and left sides so that the recording disk cartridge 1 can be easily held when it is taken out of the drive unit D (See FIG. 5).

Moreover, the cartridge case 10 has an opening for access 101 (a case opening) which is a notch formed in a wedge shape (a substantial sector with central angle of substantially 90°) in a plane view. Through the opening for access 101, the recording disk medium 30 in the cartridge case 10 is exposed outside. The opening for access 101 is formed in a shape which does not interfere with operation of a swing arm SA of the drive unit D (See FIG. 5).

As shown in FIG. 2, the cartridge case 10 includes a metal upper shell 11 and a metal lower shell 12 which face each other, and plastic frame members 13 placed between the upper shell 11 and the lower shell 12.

[Upper Shell 11 and Lower Shell 12]

The upper shell 11 mainly forms an upper wall of the cartridge case 10 while the lower shell 12 mainly forms a lower wall of the cartridge case 10. For instance, a metal plate such as a stainless steel is punched out and bent as described later to form the upper shell 11 and the lower shell 12 in predetermined shapes.

An opening for access 111 which is a wedge-shaped notch in a plane view is formed in the front left side in the upper shell 11.

Similarly, an opening for access 121 which is a wedge-shaped notch in a plane view is formed in the front left side in the lower shell 12. Thus, the opening for access 111 and the opening for access 121 together form the above-mentioned opening for access 101 of the cartridge case 10.

On the right side of the upper shell, a bent portion 112c which is bent linearly in a plane view is formed integrated with the upper shell by means of a bending process of a metal plate. Also, on the left side of the upper shell, a bent portion 112d is formed. Similarly, bent portions 122c and 122d are respectively formed on the right and left sides of the lower shell 12.

Thus, when the cartridge case 10 is assembled, the bent portions 112c and 122c overlap to form a part of a peripheral wall on the right edge 10c of the cartridge case 10. Similarly, the bent portions 112d and 122d overlap to form a part of a peripheral wall on the left edge 10d.

In addition, an engaging hole 113 is formed in the center of the upper shell 11 to engage with a center pin 50 which pivots the rotary shutter 20 turnably.

On the other hand, a hub hole 123 is formed in the center of the lower shell 12 to cause the hub 32 of the recording disk medium 30 to be exposed outside. Thus, when the recording disk cartridge 1 is mounted in the drive unit D, a spindle (not shown) of the drive unit D chucks (engages in) the hub 32 through the hub hole 123.

Moreover, the lower shell 12 has a guide hole 124 which is formed along a path of the shutter knob 24 of the rotary shutter 20, and two turn axes 125a and 125b which protrude inside (toward the side of the recording disk medium 30) to pivot the hub hole shutter 40.

[Frame Members 13]

As shown in FIG. 2, the frame members 13 includes an arch frame 131 which mainly forms a peripheral wall on the front edge 10a (See FIG. 1), a base frame 132 which mainly forms a peripheral wall on the rear edge 10b (See FIG. 1), a V notch member 133 which mainly forms a part of the front side in the peripheral wall on the left edge 10d.

A wall's inner surface 131a (a surface in the side of the recording disk medium 30) of the arch frame 131 is formed in an arc shape along a contour of the rotary shutter 20. Meanwhile, a wall's outer surface 131b (an outer surface of the recording disk cartridge 1) of the arch frame 131 is formed in an arc shape in a plane view along a contour of the front edge 10a of the cartridge case 10.

Similarly, a wall's inner surface 132a (a surface in the side of the recording disk medium 30) of the base frame 132 is formed in an arc shape along a contour of the rotary shutter 20. Meanwhile, a wall's outer surface 132b (an outer surface of the recording disk cartridge 1) of the base frame 132 is formed substantially linearly in a plane view along a contour of the rear edge 10b of the cartridge case 10.

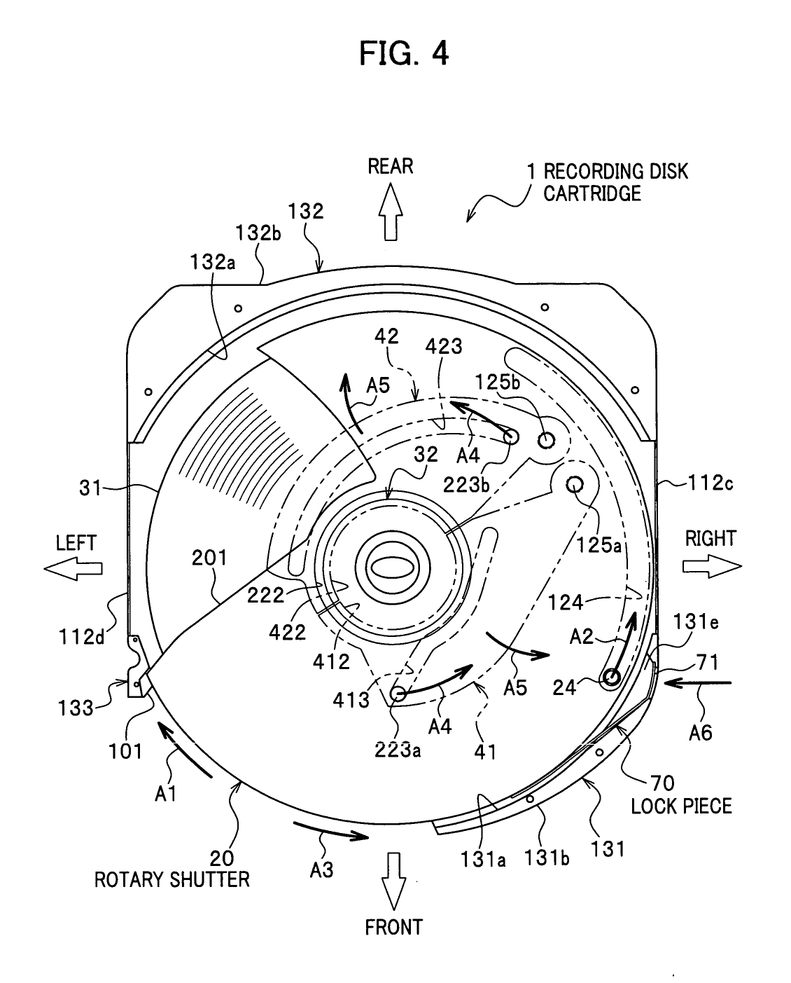

Moreover, the arch frame 131 has an engaging groove 131e (See FIG. 4) which opens downward and links inside and outside of the cartridge case 10. A lock piece 70, which will be described later, engages in the engaging groove 131e.

The V notch member 133, which is placed in the front side in the left edge 10d, serves as a stopper to stop the rotary shutter 20 in the close position (See FIG. 4), as well as an engaging portion to engage with the drive unit D. The rotary shutter 20 is pushed to the closing direction as described later.

The upper shell 11 and the lower shell 12 are respectively fixed to the frame members 13 by means of a publicly known technology. For instance, the following methods are used to attach the upper shell 11 and the lower shell 12 to the frame members 13. (1) Bosses are provided in the frame members 13; boss holes are provided in the upper shell 11 and the lower shell 12; the bosses are inserted into the boss holes; and ends of the bosses are crimped. (2) The upper shell 11 and the lower shell 12 are bonded with the frame members 13 using adhesive.

<Rotary Shutter 20>

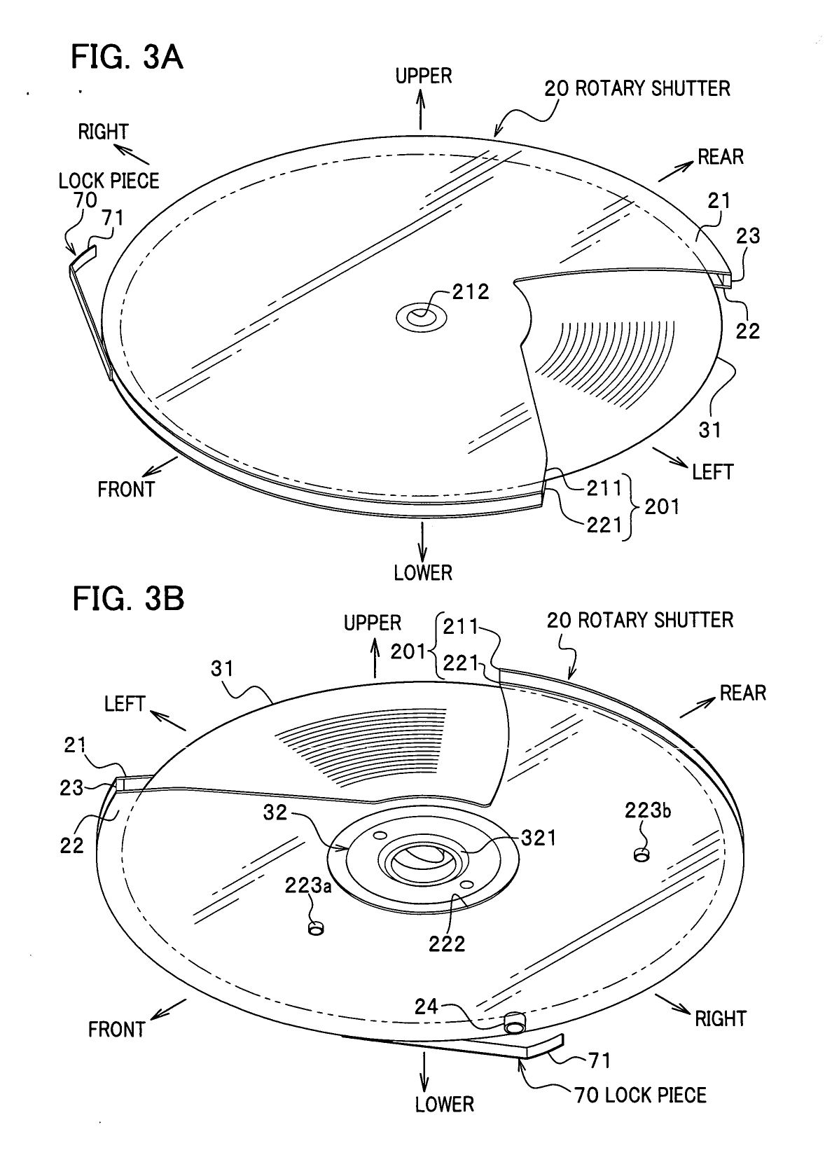

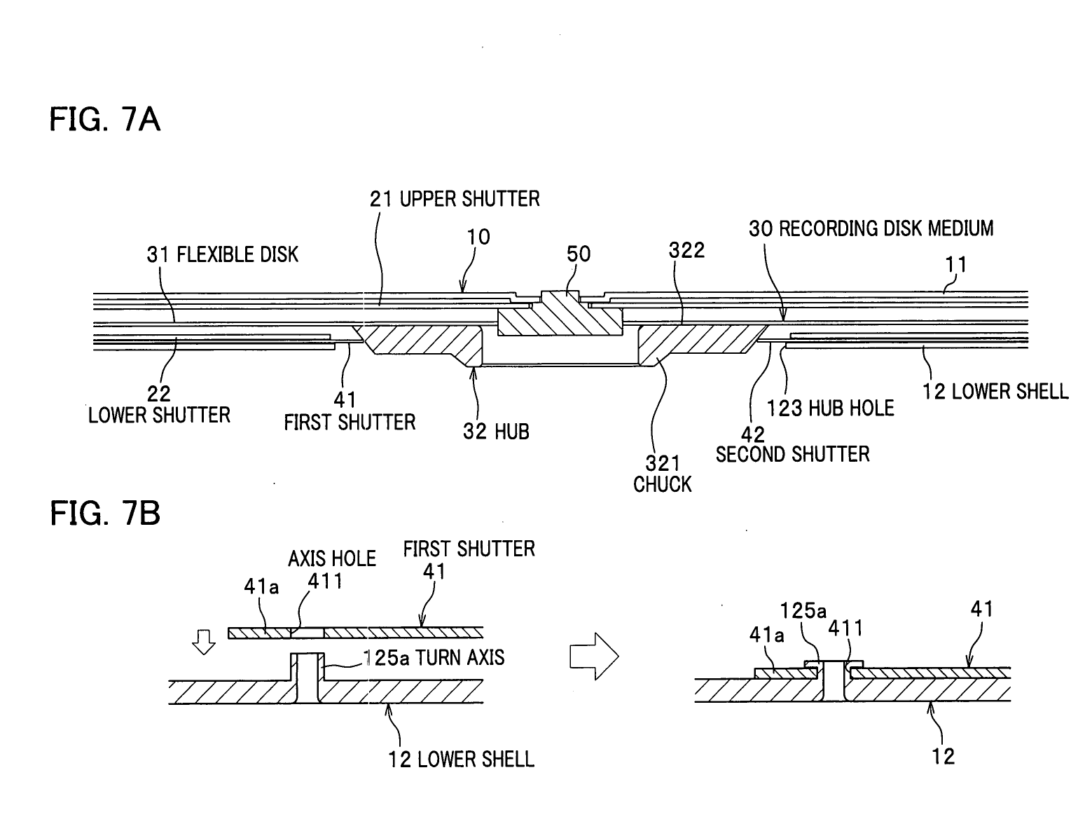

The rotary shutter 20, which is formed in a hollow substantially cylindrical shape, opens and closes the opening for access 101 (See FIG. 1). Thus, the recording disk medium 30 is rotatably provided inside the hollow in the rotary shutter 20 (See FIGS. 3A, 3B, and 7A).

As shown in FIGS. 2, 3A, and 3B, the rotary shutter 20 has a notch 201 which causes the recording disk medium 30 to be exposed outside (See FIGS. 3A and 3B). The notch 201 is formed in the substantially same shape with the opening for access 101 of the cartridge case 10.

Moreover, the rotary shutter 20 is rotatably attached near a center of the upper shell 11 with a center pin 50.

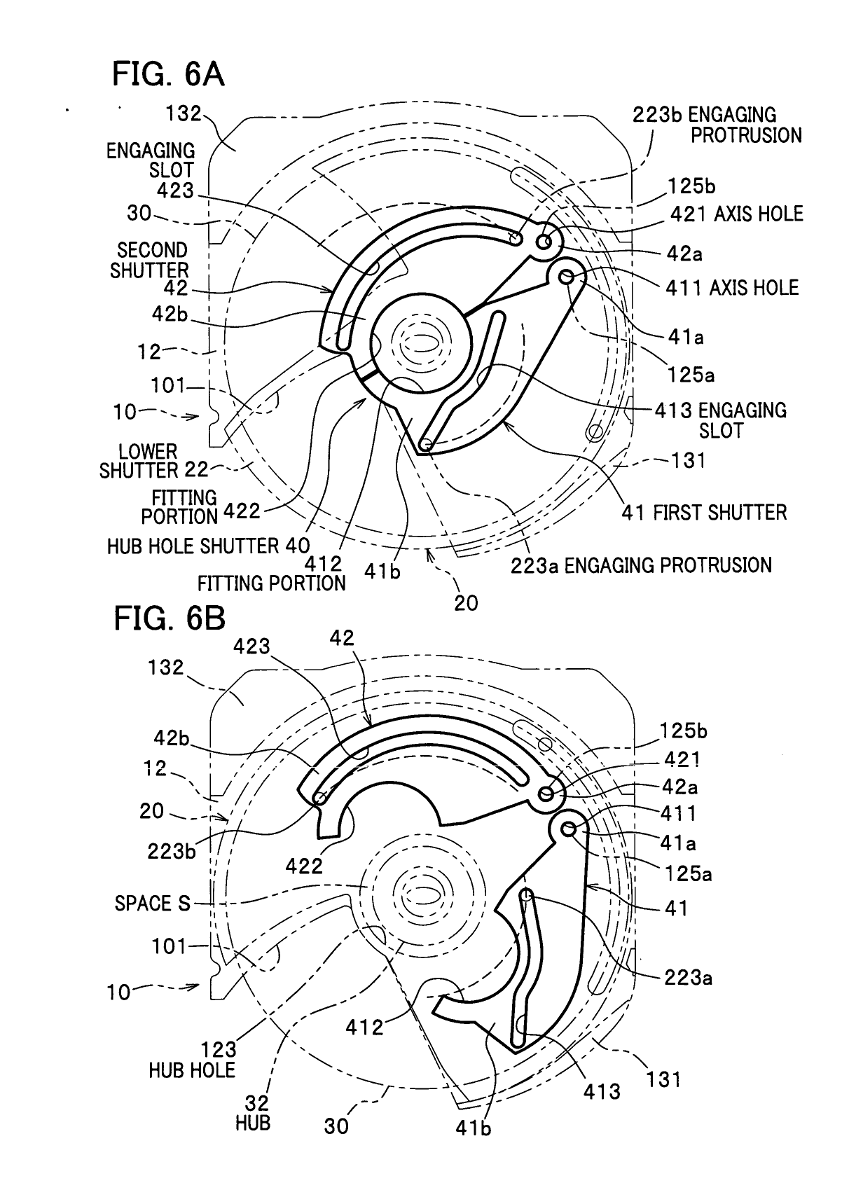

More specifically, as shown in FIGS. 5 and 6A, when the rotary shutter 20 is located in the close position, the notch 201 of the rotary shutter 20 circumferentially shifts from the opening for access 101 of the cartridge case 10. Therefore, the rotary shutter 20 closes the opening for access 101 of the cartridge case 10.

On the other hand, as shown in FIGS. 5, and 6B, when the rotary shutter 20 is located in the open position, the notch 201 matches and aligns with the opening for access 101 in the thickness direction of the recording disk cartridge 1 (the axial direction of the recording disk medium 30). Accordingly, the rotary shutter 20 opens the opening for access 101. When the opening for access 101 is opened in this way, the recording disk medium 30 is exposed outside.

The rotary shutter 20 is pushed to the closing direction (See Arrow A1 in FIG. 4) by a pushing means (for instance, a spring), which is not shown. Then, in a normal state before the recording disk cartridge 1 is inserted in the drive unit D, the rotary shutter 20, which is pushed to the closing direction, touches the V notch member 133 in the circumferential direction. Therefore, the rotary shutter 20 is located in the close position so as to close the opening for access 101 (See FIGS. 1A, 1B, 4, and 5). By the way, the pushing means is not always necessary in the invention. As described later, a stopping means (a shutter knob stopper D1) to stop the shutter knob 24 may be provided in the drive unit D. Then, when the recording disk cartridge 1 is taken out of the drive unit D (See FIG. 5), the rotary shutter 20 turns in the closing direction A1. Therefore, the pushing means can be omitted.

As shown in FIGS. 2, 3A, and 3B, the rotary shutter 20 includes an upper shutter 21 and a lower shutter 22 which are made of a metal plate, and a plastic shutter wall 23 between the upper shutter 21 and the lower shutter 22.

[Upper Shutter 21 and Lower Shutter 22]

The upper shutter 21 which forms an upper wall of the rotary shutter 20 has a wedge-shaped notch 211. The lower shutter 22 which forms a lower wall of the rotary shutter 20 has a wedge-shaped notch 221.

In addition, the notch 211 and the notch 221 form a notch 201 of the rotary shutter 20 (See FIG. 3).

The upper shutter 21 has in the center an insert hole 212 through which the center pin 50 is inserted.

The lower shutter 22 has in the center a shutter hub hole 222 so as to cause the hub 32, which will be described later, of the recording disk medium 30 to be exposed outside.

Moreover, an engaging protrusion (a protrusion) 223a which engages in an engaging slot (a slot) 413 of the hub hole shutter 40, and an engaging protrusion (a protrusion) 223b which engages in an engaging slot (a slot) 423 of the hub hole shutter 40, are formed in a side of a lower shell in the lower shutter 22. Thus, the hub hole shutter 40 turns in synchronization with turning of the rotary shutter 20 since the engaging protrusions 223a and 223b respectively engage in the slots 413 and 423.

A shutter knob 24 which turns the rotary shutter 20 is attached to a lower surface of the lower shutter 22 (See FIG. 3B). The shutter knob 24 (See FIG. 1B) protrudes from the lower surface of the recording disk cartridge 1 through the guide hole 124 formed in the lower shell 12 of the cartridge case 10. Thus, when the recording disk cartridge 1 is inserted in the drive unit D, the shutter knob stopper D1 of the drive unit D stops the shutter knob 24 (See FIG. 5).

Moreover, as shown in FIGS. 3A, 3B, and 4, the lower shutter 22 includes a lock piece 70 (a lock mechanism) which is integrated with the lower shutter 22 and a part of which is bent toward upper side. The lock piece locks the rotary shutter in the close position in the normal state before the recording disk cartridge is inserted. More specifically, the lock piece 70 is a long metal piece which extends from a side surface of the lower shutter 22 getting gradually further in an outer radial direction. An end 71 of the lock piece 70 is a little bent in an inner radial direction.

Accordingly, as shown in FIG. 4, in the normal state before the recording disk cartridge 1 is inserted in the drive unit D, the rotary shutter 20 is located in the close position and the end 71 of the lock piece 70 engages in an engaging groove 131e of an arch frame 131 so that the rotary shutter 20 cannot turn.

Moreover, the end 71 of the lock piece 70 faces the right side of the recording disk cartridge 1 through the engaging groove 131e. Therefore, when the recording disk cartridge 1 is inserted in the drive unit D (See FIG. 6), an unlock pin (not shown) in the drive unit D pushes the end 71 of the lock piece 70 in the inner radial direction (See Arrow A6 in FIG. 4). Then, the lock piece 70 is released from the engaging groove 131e so that the rotary shutter 20 can turn.

[Shutter Wall 23]

The shutter wall 23 forms a peripheral wall of the rotary shutter 20. As shown in FIG. 2, the shutter wall 23 is a resinous component which is formed in C-shape in a plane view and in which a portion corresponding to the notch 201 of the rotary shutter 20 is cut out. Moreover, the upper shutter 21 and the lower shutter 22 are respectively attached on upper and lower sides of the shutter wall 23 by an appropriate means similarly to the cartridge case 10. Thus, the shutter wall 23 is placed between the upper shutter 21 and the lower shutter 22 so as to form a space to contain the recording disk medium 30.

<Recording Disk Medium 30>

In the embodiment, as shown in FIG. 2, the recording disk medium 30 is a recording medium which stores data and includes a flexible disk 31 and a hub 32 to support the flexible disk 31.

The flexible disk 31 includes a discoid support medium made of, for instance, a polyester sheet or the like and recording layers such as magnetic layers formed on both surfaces of the support medium.

As shown in FIG. 7A, the hub 32 is a metallic cylindrical component which supports the flexible disk 31. Moreover, the hub 32 includes an attachment 322 in the upper surface to attach the flexible disk 31 and a chuck 321 in the lower surface to chuck the spindle (not shown) of the drive unit D (See FIG. 5). The lower portion of the hub 32 protrudes outside through the hub hole 123 which is formed in the lower shell 12.

<Liners 60>

As shown in FIG. 2, liners 60 and 60, which are formed of, for instance, nonwoven fabric or the like, clean up and protect the recording disk medium 30. The liners 60 and 60 are respectively placed on sides of the flexible disk 31 (the recording disk medium 30) of the upper shutter 21 and the lower shutter 22 and bonded with the upper shutter 21 and the lower shutter 22 through adhesive layers (not shown).

<Hub Hole Shutter 40>

As shown in FIGS. 6A and 6B, the hub hole shutter 40 opens and closes a space S (See FIG. 5) between the lower shell 12 and the hub 32 in synchronization with opening and closing of the opening for access 101 by the rotary shutter 20. The hub hole shutter 40 includes a first shutter (a shutter) 41 and a second shutter (a shutter) 42 provided on the both sides of the hub 32 between the lower surface of the rotary shutter 20 and the inner surface of the lower shell 12. The first shutter 41 and the second shutter 42 turn in synchronization with turning of the rotary shutter 20 so as to open and close the space S between the lower shell 12 and the hub 32. FIG. 6A shows a state where the first shutter 41 and the second shutter 42 close while FIG. 6B shows a state where the first shutter 41 and the second shutter 42 open.

As shown in FIG. 6A, the first shutter 41 and the second shutter 42 are tabular components shaped in a semicircle in a plane view. The first shutter 41 has an axis hole 411 on one edge 41a. Similarly, the second shutter 42 has an axis hole 421 on one edge 42a. Thus, the turn axis 125a provided in the inner surface of the lower shell 12 is inserted in the axis hole 411. Similarly, the turn axis 125b provided in the inner surface of the lower shell 12 is inserted in the axis hole 421.

Accordingly, the first shutter 41 and the second shutter 42 are respectively pivoted on the turn axes 125a and 125b of the cartridge case 10. Thus, the first shutter 41 and the second shutter 42 are individually pivoted on the cartridge case 10.

The turn axes 125a and 125b are cylindrical axes which are protruded from the inner surface of the lower shell 12 by means of a burring process and formed in the right rear side in the lower shell 12 (See FIG. 2).

As shown in the left half in FIG. 7B, to attach the first shutter 41, the turn axis 125a of the lower shell 12 is inserted into the axis hole 411 formed in the one edge 41a. Then, as shown in the right half in FIG. 7B, the end of the turn axis 125a is crimped so that the first shutter 41 is loosely supported by the turn axis 125a. Similarly, the second shutter 42 shown in FIG. 6A is also supported by the turn axis 125b of the lower shell 12.

Heights of the turn axes 125a and 125b before a crimping-process are preferably 1.5-3 times, and more preferably 1.5-2 times of mean thicknesses of the first shutter 41 and the second shutter 42 to attain sufficient crimping area and strength.

Moreover, as shown in FIG. 6A, in the other edge 41b, the first shutter 41 has a fitting portion 412 which is a hemicycle notch and fits with the lower portion (See FIG. 7A) of the hub 32 protruding through the hub hole 123 of the lower shell 12. Similarly, the second shutter 42 has a fitting portion 422 in the other edge 42b. Thus, in the normal state before the recording disk cartridge 1 is inserted in the drive unit D, the first shutter 41 and the second shutter 42 together surround the hub 32 from both sides to close the space S.

In addition, in the first shutter 41, an engaging slot 413 in which an engaging protrusion 223a in the lower surface of the lower shutter 22 engages is formed along from the one edge 41a to the other edge 41b.

Similarly, in the second shutter 42, an engaging slot 423 in which an engaging protrusion 223b in the lower surface of the lower shutter 22 engages is formed along from the one edge 42a to the other edge 42b.

Shapes in a plane view of the engaging slots 413 and 423 are designed so that the engaging protrusions 223a and 223b turn integrally with the rotary shutter 20 so as to cause the first shutter 41 and the second shutter 42 to turn to cause the hub hole shutter 40 to open and close the space S.

To be concrete, in the state in FIG. 6A where the first shutter 41 and the second shutter 42 are closed, the engaging protrusion 223a engages in the end in the side of the other edge 41b in the engaging slot 413 of the first shutter 41 while the engaging protrusion 223b engages in the end in the side of the one edge 42a in the engaging slot 423 of the second shutter 42.

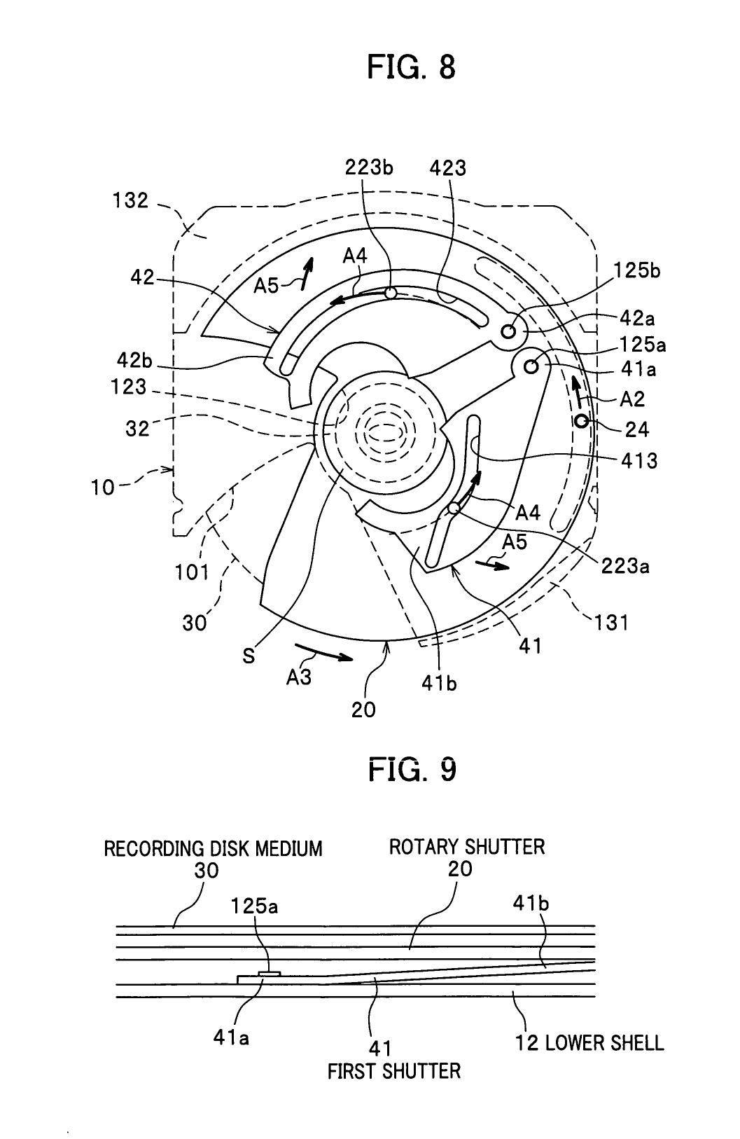

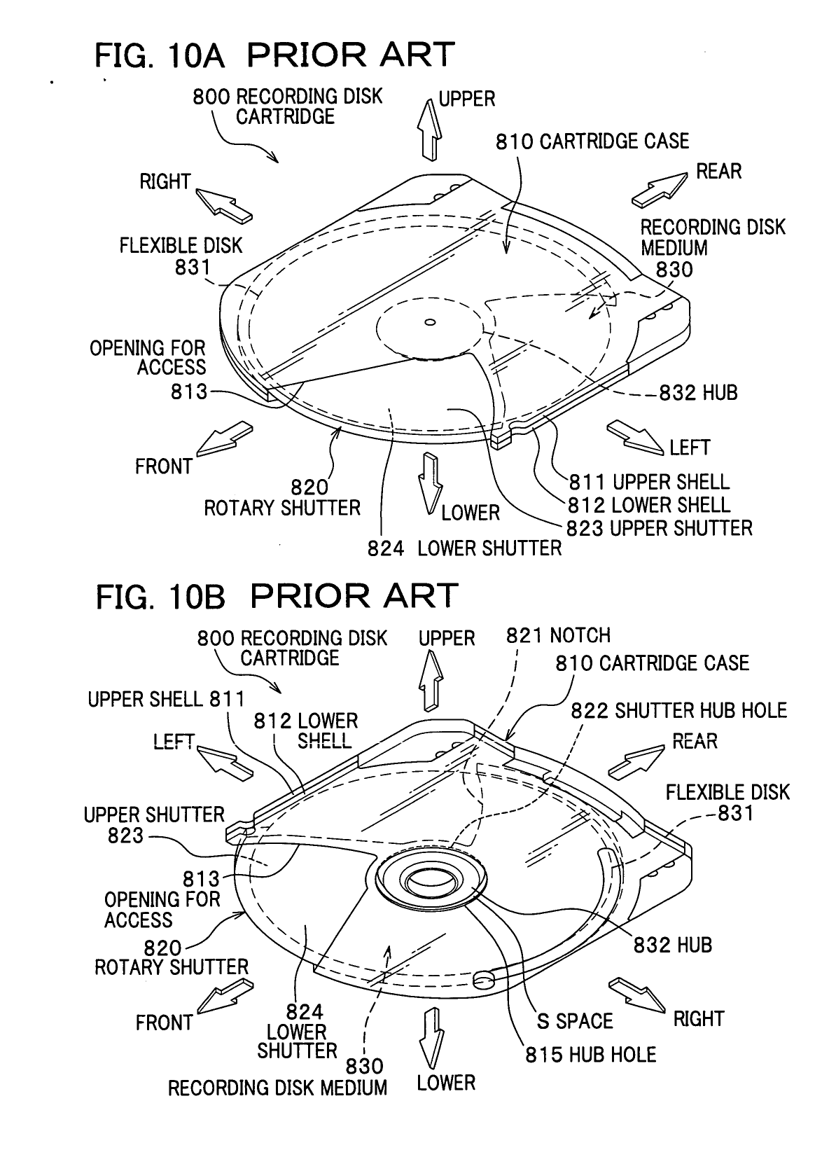

As shown in FIG. 8, when the rotary shutter 20 turns in the direction of Arrow A3 to open the opening for access 101, the engaging protrusion 223b moves along a path concentric with the rotary shutter 20 in the direction of Arrow A4. At this time, the engaging protrusion 223b slides from the side of the one edge 42a to the side of the other edge 42b in the engaging slot 423 of the second shutter 42 pushing the second shutter 42 outside. For this purpose, the engaging slot 423 of the second shutter 42 is shaped in an arc whose center is displaced from the turn center of the rotary shutter 20.

Accordingly, when the rotary shutter 20 turns in the direction of Arrow A3 to open the opening for access 101, the second shutter 42 is pushed outside by the engaging protrusion 223b. Thus, the second shutter 42 turns in the direction of Arrow A5 around the turn axis 125b as a center so that the second shutter 42 opens.

The outer peripheral of the second shutter 42 is shaped in an arc so that the second shutter 42 does not interfere with the base frame 132 until the rotary shutter 20 stops turning.

In the first shutter 41, when the rotary shutter 20 turns in the direction of Arrow A3 to open the opening for access 101, the engaging protrusion 223a moves along a path concentric with the rotary shutter 20 in the direction of Arrow A4. At this time, the engaging protrusion 223a slides from the side of the other edge 41b to the side of the one edge 41a in the engaging slot 413 of the first shutter 41 pushing the first shutter 41 outside. For this purpose, the engaging slot 413 of the first shutter 41 is shaped in an arc whose center is displaced from the turn center of the rotary shutter 20.

Accordingly, when the rotary shutter 20 turns in the direction of Arrow A3 to open the opening for access 101, the first shutter 41 is pushed outside by the engaging protrusion 223a. Thus, the first shutter 41 turns in the direction of Arrow A5 around the turn axis 125a as a center so that the first shutter 41 opens.

The outer peripheral of the first shutter 41 is shaped in an arc so that the first shutter 41 does not interfere with the base frame 132 until the rotary shutter 20 stops turning.

Here, in the state shown in FIG. 6A where the first shutter 41 and the second shutter 42 are closed, the engaging protrusion 223a engages in the end in the side of the other edge 41b in the engaging slot 413 of the first shutter 41. Therefore, a distance from the turn axis 125a, which is the turn center of the first shutter 41, to the engaging protrusion 223a is long. On the other hand, a distance from the turn axis 125b, which is the turn center of the second shutter 42, to the engaging protrusion 223b is short.

As a result, when the rotary shutter 20 starts turning, an angular velocity of the engaging protrusion 223a with respect to the turn axis 125a is smaller than an angular velocity of the engaging protrusion 223b with respect to the turn axis 125b.

Therefore, in a case where the engaging slot 413 of the first shutter 41 is shaped in a predetermined arc similar to the engaging slot 423 of the second shutter 42, a pushing velocity of the first shutter 41 (an opening velocity of the shutter) by the engaging protrusion 223a is smaller than a pushing velocity of the second shutter 42 (an opening velocity of the shutter) by the engaging protrusion 223b. In other words, the first shutter 41 opens more slowly than the second shutter 42.

For this reason, in the first shutter 41 of the embodiment, the side of the other edge 41b in the engaging slot 413 curves in a direction from the turn center toward outside. Moreover, in the side of the other edge 41b in the engaging slot 413, the engaging protrusion 223a which turns in the direction of Arrow A4 supplementarily pushes the first shutter 41. Thus, the first shutter 41 and the second shutter 42 start opening at the same opening velocity.

<<Operation-Effect of Recording Disk Cartridge>>

Next, operation-effect of the recording disk cartridge 1 will be described. At first, operation of the rotary shutter 20 will be described. After that, operation and operation-effect of the hub hole shutter 40 will be described.

<Operation of Rotary Shutter 20>

As shown in the right half in FIG. 5, the rotary shutter 20 is located in the close position in the normal state of the recording disk cartridge 1 (before being inserted in the drive unit D) so that the opening for access 101 is closed. More specifically, in the normal state, the opening for access 101 of the cartridge case 10 does not match or align with the notch 201 of the rotary shutter 20 so as to cause the opening for access 101 to be closed. Therefore, it is possible to prevent dust from entering the cartridge case 10 through the opening for access 101. As a result, the recording disk medium 30 and so on are protected.

Moreover, when the rotary shutter 20 is thus located in the close position, the shutter knob 24 is located in a front side in the guide hole 124 of the lower shell 12.

Then, when the recording disk cartridge I is inserted in the cartridge slot DS of the drive unit D, the unlock pin of the drive unit D (not shown) pushes the end 71 of the lock piece 70 in the inner radial direction. Thus, after lock of the rotary shutter 20 by the lock piece 70 is released (See Arrow A6 in FIG. 4), the shutter knob 24 is caught and stopped by the shutter knob stopper D1 of the drive unit D. Therefore, when the recording disk cartridge 1 is further inserted keeping the shutter knob 24 stopped by the shutter knob stopper D1, the shutter knob 24 slides along the guide hole 124 (See Arrow A2 in FIG. 4).

Accordingly, the rotary shutter 20 with the stopped shutter knob 24 turns around the center pin 50 as an axis inside the cartridge case 10 (See Arrow A3 in FIG. 4). In other words, the rotary shutter 20 turns relatively to the cartridge case 10. The opening for access 101 opens gradually in the drive unit D in synchronization with turning of the rotary shutter 20.

As shown in the left half in FIG. 5, when the recording disk cartridge 1 is completely inserted and mounted in the drive unit D, the notch 201 of the rotary shutter 20 matches and aligns with the opening for access 101 of the cartridge case 10. Therefore, the rotary shutter 20 is located in the open position so that the opening for access 101 completely opens. As a result, the recording disk medium 30 is exposed outside through the notch 201 and the opening for access 101 from inside of the drive unit D. Accordingly, the head of the swing arm SA of the drive unit D can read/write data from/to the recording disk medium 30.

In a case where the rotary shutter 20 is located in the open position, the shutter knob 24 fixed to the rotary shutter 20 is located in the rear side in the guide hole 124 of the lower shell 12.

Moreover, when the recording disk cartridge 1 is taken out of the drive unit D, the rotary shutter 20 is pushed in the closing direction by the pushing means (not shown) so as to return to the close position and close the opening for access 101. Thus, when the rotary shutter 20 returns to the close position, the lock piece 70 locks the rotary shutter 20 (See FIG. 4).

<Operation and Operation-Effect of Hub Hole Shutter 40>

Next, the hub hole shutter 40 which operates in synchronization with the operation of the rotary shutter 20 will be described. As shown in the right half in FIG. 5, and FIG. 6A, the hub hole shutter 40 covers the space S between the lower shell 12 of the cartridge case 10 and the hub 32 in the normal state of the recording disk cartridge 1 (before being inserted in the drive unit D, in the case where the rotary shutter 20 is located in the close position).

More specifically, the first shutter 41 and the second shutter 42, which form the hub hole shutter 40, together surround the hub 32 from the both sides between the lower shell 12 and the recording disk medium 30 so as to cover the space S.

Accordingly, it is possible to prevent dust from entering the cartridge case 10 through the space S. As a result, the recording disk medium 30 and so on are protected so that a read error can be prevented in the recording disk medium 30.

Moreover, the first shutter 41 and the second shutter 42 together surround the hub 32 from the both sides. Therefore, the hub hole shutter 40 can completely cover the whole peripheral of the space S between the hub hole 123 and the hub 32.

As shown in the left half in FIG. 5, and FIG. 8, when the recording disk cartridge 1 is inserted in the drive unit D and the rotary shutter 20 turns as described above, the engaging protrusion 223a turns in the direction of Arrow A4. The engaging protrusion 223a, which engages in the slot 413 of the first shutter 41, turns and slides in the engaging slot 413 pushing the first shutter 41. Therefore, the first shutter 41 turns around the turn axis 125a of the lower shell 12 as an axis in the direction of Arrow A5 so as to move away from the hub 32.

Similarly, when the engaging protrusion 223b turns in the direction of Arrow A4 in synchronization with turning of the rotary shutter 20, the engaging protrusion 223b, which engages in the engaging slot 423 of the second shutter 42, turns and slides in the engaging slot 423 pushing the second shutter 42. Therefore, the second shutter 42 turns around the turn axis 125b of the lower shell 12 as an axis in the direction of Arrow A5 so as to move away from the hub 32.

As described above, when the rotary shutter 20 starts turning, an angular velocity of the engaging protrusion 223a with respect to the turn axis 125a which pivots the first shutter 41 is smaller than an angular velocity of the engaging protrusion 223b with respect to the turn axis 125b which pivots the second shutter 42. However, in the first shutter 41, the side of the other edge 41b in the engaging slot 413 curves in the direction from the turn center toward outside. In addition, in the side of the other edge 41b in the engaging slot 413, the engaging protrusion 223a which turns in the direction of Arrow A4 supplementarily pushes the first shutter 41. Therefore, the first shutter 41 and the second shutter 42 start opening at the same opening velocity.

Moreover, the engaging protrusions 223a and 223b in the lower surface of the rotary shutter 20 are respectively inserted and engaged in the engaging slots 413 and 423 formed in the first shutter 41 and the second shutter 42 of the hub hole shutter 40 so that the rotary shutter 20 can easily and exactly engages with the hub hole shutter 40. Therefore, the first shutter 41 and the second shutter 42 exactly turn in synchronization with turning of the rotary shutter 20.

Thus, as shown in FIG. 6B, when the first shutter 41 and the second shutter 42 respectively turn and move away from the hub 32, the hub hole shutter 40 opens the space S. At the same time, the hub 32 is released from the surrounding hub hole shutter 40 (See the left half in FIG. 5). As a result, the hub 32 can move in the hub hole 123. Therefore, when the hub 32 is chucked by the spindle (not shown) of the drive unit D, position of the hub 32 can be easily adjusted corresponding to position of the spindle. Thus, the spindle (not shown) of the drive unit D, which chucks the hub 32 can appropriately turn the hub 32 and the recording disk medium 30 including the hub 32.

When the recording disk cartridge 1 is taken out of the drive unit, the hub hole shutter 40 closes the space S in synchronization with the rotary shutter 20 which turns and returns to the close position.

Thus, the hub hole shutter 40 turns in synchronization with turning of the rotary shutter 20 which opens and closes the opening for access 101 of the cartridge case 10 so as to open and close the space S between the hub hole 123 of the cartridge case 10 and the hub 32 of the recording disk medium 30. Therefore, dust is prevented from entering the cartridge case 10 through the space S so that the recording disk medium 30 and so on inside the cartridge case 10 can be protected.

Moreover, in the hub hole shutter 40 of the embodiment, the first shutter 41 and the second shutter 42 are respectively pivoted to the lower shell 12 of the cartridge case 10. Thus, the first shutter 41 and the second shutter 42 are supported without overlap to open and close the space S between the hub hole 123 and the hub 32. Therefore, the hub hole shutter 40 can be thin and employed for a thin recording disk cartridge 1.

In addition, the turn axes 125a and 125b, which are protruded from the inner surface of the lower shell 12 of the cartridge case 10 by means of a burring process, are respectively inserted through the axis holes 411 and 421 formed in the first shutter 41 and the second shutter 42. Then, the ends of the turn axes 125a and 125b are crimped. Thus, the hub hole shutter 40 is supported by the lower shell 12 (See FIG. 7B). Therefore, axes do not need to be attached as separate parts to support the first shutter 41 and the second shutter 42. As a result, the hub hole shutter 40 can be easily assembled.

Description has been given to a preferred embodiment of the present invention, above. The invention is not limited to the embodiment, but may be modified as described below, for instance, within the spirit of the invention.

For instance, the recording disk medium is not limited to a magnetic disk medium. An optical disk medium such as a magnet-optical disk medium and a phase change disk medium may be used as the recording disk medium. In addition, the recording disk medium is not limited to a flexible disk medium either. A rigid disk medium such as a DVD-RAM may be used as the recording disk medium.

Moreover, as shown in FIG. 4, in the embodiment, the hub hole shutter 40 has two shutters, that is, the first shutter 41 and the second shutter 42. However, the number of the shutters included in the hub hole shutter 40 is not limited to this. Two or more shutters may be included as long as a sufficient space for the shutters is available inside the cartridge case 10. Furthermore, only one shutter may be included in the hub hole shutter. In this case, the space S between the hub hole 123 and the hub 32 cannot be entirely covered by the hub hole shutter. However, dust which enters the cartridge case 10 through the space S can be dramatically reduced.

Moreover, as shown in the side sectional view in FIG. 9, a side of the other edge 41b (or 42b) in the first shutter 41 (or the second shutter 42) is inclined to the lower surface of the rotary shutter 20 so as to cause the side of the other edge 41b (or 42b) to approach the lower surface of the rotary shutter 20.

In this case, the engaging protrusions 223a and 223b in the lower surface of the rotary shutter 20 are deeply inserted in the engaging slots 413 and 423 in the sides of the other edges 41b and 42b. Therefore, the engaging protrusions 223a and 223b can be prevented from detaching from the engaging slots 413 and 423 even in the sides of the other edge 41b and 42b which are free and shaky so that the first shutter 41 and the second shutter 42 can exactly turn.

Inclination angles in the sides of the other edges 41b and 42b are preferably small, for instance, about 1°, so as to prevent the other edges 41b and 42b from strongly rubbing the lower surface of the rotary shutter 20.

According to the present invention, the hub hole shutter can turn in synchronization with turning of the rotary shutter which opens and closes the case opening of the cartridge case so as to open and close the space between the hub hole of the cartridge case and the hub of the recording disk medium. Therefore, dust can be prevented from entering the cartridge case through the space so that the recording disk medium and so on inside the cartridge case can be protected.

While the described embodiments represent the preferred forms of the present invention, it is to be distinctly understood that the invention is not limited thereto but may be otherwise variously embodied within the spirit and scope of the following claims.

What is claimed is:

1. A recording disk cartridge comprising:
a recording disk medium;
a cartridge case which contains the recording disk medium and has a case opening to cause the recording disk medium to be exposed outside; and
a rotary shutter which turns between the recording disk medium and the cartridge case in order to open and close the case opening, wherein
in the cartridge case, a hub hole is formed so as to cause a hub which supports the recording disk medium to be exposed outside, wherein
a hub hole shutter comprises a shutter in which one edge is pivoted on an inner surface of the cartridge case and a fitting portion is formed on another edge to fit with the hub, and wherein
the shutter of the hub hole shutter engages with the rotary shutter and turns in synchronization with turning of the rotary shutter so as to open and close a space between the hub hole and the hub.

2. The recording disk cartridge as claimed in claim 1, wherein
the hub hole shutter comprises a plurality of shutters, and wherein
the one edge of each of the shutters is pivoted on the cartridge case and the other edges of the shutters together surround the hub so as to close the space between the hub hole and the hub.

3. The recording disk cartridge as claimed in claim 1, wherein
a slot in which a protrusion of the rotary shutter is inserted and engaged is formed in the shutter of the hub hole shutter.

4. The recording disk cartridge as claimed in claim 2, wherein
a slot in which a protrusion of the rotary shutter is inserted and engaged is formed in the shutter of the hub hole shutter.

5. The recording disk cartridge as claimed in claim 3, wherein
in the shutter of the hub hole shutter, a side of the other edge is inclined toward the rotary shutter.

6. The recording disk cartridge as claimed in claim 4, wherein
in the shutter of the hub hole shutter, a side of the other edge is inclined toward the rotary shutter.

7. The recording disk cartridge as claimed in claim 1, wherein
in the shutter of the hub hole shutter, an axis hole is formed in the one edge, an axis is protruded from an inner surface of the cartridge case by means of a burring process and inserted into the axis hole, and then an end of the axis is crimped.

8. The recording disk cartridge as claimed in claim 6, wherein
in the shutter of the hub hole shutter, an axis hole is formed in the one edge, an axis is protruded from an inner surface of the cartridge case by means of a burring process and inserted into the axis hole, and then an end of the axis is crimped.

9. The recording disk cartridge as claimed in claim 3, wherein
the hub hole shutter comprises a first shutter and a second shutter, wherein
the slots of the first shutter and the second shutter are shaped in an arc whose centers are displaced from the turn center of the rotary shutter, and wherein
in the slot of the first shutter, a side of the other edge curves in a direction from the turn center of the rotary shutter toward outside.

10. The recording disk cartridge as claimed in claim 6, wherein
the hub hole shutter comprises a first shutter and a second shutter, wherein
the slots of the first shutter and the second shutter are shaped in an arc whose centers are displaced from the turn center of the rotary shutter, and wherein
in the slot of the first shutter, a side of the other edge curves in a direction from the turn center of the rotary shutter toward outside.
